(19) United States
(12) Patent Application Publication
(10) Pub. No.: US 2007/0042150 A1
(43) Pub. Date: Feb. 22, 2007

(54) ADHESIVE COVERINGS AND METHODS OF PRODUCING AND USING THE SAME

(76) Inventors: John R. Hopkins, Bow Mar, CO (US); Timothy Roger Schettler, Castle Rock, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/458,197

(22) Filed: Jul. 18, 2006

Related U.S. Application Data
(60) Provisional application No. 60/700,117, filed on Jul. 18, 2005.

(51) Int. Cl. B32B 33/00

(52) U.S. Cl. 428/40.1

(57) ABSTRACT

An adhesive covering including a backing layer, a first adhesive having a first surface in contact with at least a portion of the backing layer, the first adhesive further having a first bonding strength in relation to a surface, and a second adhesive adapted to provide a second bonding strength in relation to the surface. The second adhesive may be activated to enable the covering to be maintained in a desired orientation at least until the first adhesive bonds to the surface.

### CROSS-REFERENCE TO RELATED APPLICATIONS

This application is related to U.S. Provisional Patent Application No. 60/700,117, entitled “WATERPROOF COVERINGS AND THEIR APPLICATION” filed Jul. 18, 2005, and which is incorporated herein by reference in its entirety.

### FIELD OF THE INVENTION

The present invention relates broadly to adhesive coverings and methods for producing and using the same. More particularly, the present invention relates to a multi-adhesive covering that includes an adhesive membrane that provides a primary bonding strength and a second adhesive that provides a secondary bonding strength and methods for producing such multi-adhesive coverings.

### BACKGROUND OF THE INVENTION

In many instances, it is desirable to apply a membrane material to a substrate to achieve a desired outcome. For example, in the construction industry it is often desirable to apply a waterproof membrane to the surface of, for example, wood and other materials. Such membranes may include an adhesive layer of, for example, a bitumen-containing material, such as butyl rubber (polyisobutylene). These materials can act both to adhere the membrane to a surface as well as provide a waterproof covering for that surface. However, in certain circumstances, the membrane may be in place for a period of time before suitable bonding between the adhesive layer and the substrate occurs. That is, when a membrane is first applied to a surface, the adhesion (bonding) strength of the adhesive layer, in itself, may be insufficient to maintain the membrane in the desired orientation in relation to the surface. In such instances, the membrane may be attached by other materials not integral to the membrane, such as nails and staples, to keep the membrane in place until the adhesive layer can bond to the surface. These attachment techniques are labor and time intensive and add to the capital cost of constructing a building. Moreover, the use of nails and staples punctures the membrane, thereby creating locations for possible weather and/or organism intrusion to an underlying substrate.

Another desired use of membrane materials in relation to the construction industry is to prevent rodents, insects and other unwanted organisms from damaging or destroying the structure of the building. While in many instances the membrane material itself is sufficient to ward off such organisms, there are times when species, such as termites, may be able to penetrate the membrane, which can expose an underlying substrate to weather and organisms that may degrade the underlying substrate.

### SUMMARY OF THE INVENTION

In view of the foregoing, it is an object of the present invention to provide a readily attachable covering that does not require non-integral materials to maintain the covering in place after orienting the covering in relation to a surface.

It is a further object of the invention to provide a readily attachable covering that is waterproof and relatively light, thin and easy to apply to a surface.

It is a further object of the invention to provide a covering adapted to deter and/or terminate insects, rodents, pests and other organisms that may otherwise damage or destroy a substrate or penetrate the interior of the building.

In accordance with the above objectives, the inventors of the present invention have recognized that it is sometimes difficult to attach adhesive membranes to various surfaces including those utilized in the construction of buildings and in particular oriented strandboard (“OSB”). In this regard, the inventors of the present invention have recognized that an adhesive membrane forming a primary adhesive may be utilized in conjunction with a secondary adhesive to initially attach an adhesive membrane to surfaces which provide limited initial adhesion to the primary adhesive of the adhesive membrane. The inventors have further recognized that in some instances it may be desirable to maintain the second adhesive in an inactive state until a desired time. In this regard, the inventors have recognized that the second adhesive may be, for example, covered by a release sheet and/or encapsulated in rupturable capsules until activation is desired. Such activation (e.g., removal of a release sheet and/or rupture) may allow the second adhesive to provide additional adhesion between a surface and the adhesive membrane. The inventors have also recognized that, in arrangements utilizing capsules, such capsules may be integrated with the adhesive membrane by admixing the capsules within a matrix of the membrane and/or by applying the capsules to a surface of the adhesive membrane. The inventors of the present invention have further recognized that other chemicals may also be utilized in capsules included in an adhesive membrane to impart desired properties to the adhesive membrane, such as organism repellant chemicals.

The above objects are achieved by the present invention, which provides for an adhesive covering including a backing layer, a first adhesive layer and a second adhesive, where the backing layer and first adhesive layer generally define an adhesive membrane. The first adhesive layer has a first surface in contact with at least a portion of the backing layer and a second surface opposing the first surface. The second adhesive is compositionally different than the first adhesive and is associated with the second surface of the first adhesive. An optional peel-way release layer may be disposed over the second surface, and the first adhesive layer may be disposed between the backing layer and the peel-away release layer.

The first adhesive generally has a first bonding strength in relation to a surface and the second adhesive has a second bonding strength in relation to that surface. During a first time period, the second adhesive provides an initial bonding strength that allows the covering to be maintained in a desired relationship with a surface while the first adhesive bonds to that surface. In one arrangement, the second adhesive may be applied to a portion or all of the surface of the first adhesive layer and covered with a release layer. In this arrangement, the second adhesive may be prepared for use by removing the release layer. In another arrangement, the second adhesive may require activation in addition to removing the release layer. For instance, the second adhesive may be activated by rupturing capsules containing the second adhesive. In any arrangement, the second adhesive may assist in initially adhering the covering to the surface.

Generally, the bonding strength of the second adhesive is sufficient to enable the second adhesive to maintain the covering in a desired orientation at least for a duration sufficient to enable the first adhesive to bond to the surface. In this regard, the initial bonding strength of the second adhesive is generally greater then the initial bonding strength of the first adhesive. During a subsequent or second period of time, the bonding strength of the first adhesive may be as large or larger than the bonding strength of the second adhesive. In some instances, the bonding strength of the first adhesive during the second period of time may be sufficient to permanently fuse the covering to the surface. Moreover, the first adhesive may not only evidence adhesive qualities, but may further evidence other desired qualities such as being waterproof. In this regard, the first adhesive may include a bitumen-containing material, such as rubberized asphalt and/or butyl rubber components.

As noted above, the second adhesive is associated with the second surface of the first adhesive layer. In this regard, it will be appreciated that the second adhesive may be associated in any manner that enables the second adhesive to bond to a surface to which the covering is to be applied. For example, the second adhesive may be associated with a second surface of the first adhesive layer by entirely placing it in within the bounds of the first adhesive layer, where, upon activation, the second adhesive is able to fluidly communicate with the second surface of the first adhesive layer as well as a surface to which the covering is to be bonded. In one approach, the second adhesive is in admixture with the first adhesive and within the first adhesive layer. In such an approach, the second adhesive may be able to permeate to the second surface of the first adhesive layer. Alternatively, the second adhesive may be associated with the second surface of the first adhesive layer by placing the second adhesive outside of the bounds of the first adhesive layer, for example, proximal to or on the second surface of the first adhesive layer. In any arrangement, the second adhesive is able to fluidly communicate with the second surface of the first adhesive as well as a surface to which the covering is to be bonded. It will be appreciated that various arrangements can be utilized to associate the second adhesive with the second surface of the first adhesive layer to create the adhesive covering, such as by using a portion of the second adhesive within the bounds of the first adhesive layer, and using another portion of the second adhesive only partially within the bounds of the first adhesive layer or outside of the bounds of the first adhesive layer, but proximal to or on the perimeter of the first adhesive layer.

The manner of associating the second adhesive with the first adhesive layer maybe accomplished by any known means. In one approach, the second adhesive may be disposed (e.g., sprayed) directly on a portion (e.g., perimeter) or the entirety of the second surface of the first adhesive layer. In another approach, a plurality of capsules are used to accomplish the associating, where each of the capsules contains a portion of the second adhesive. In one such arrangement, the capsules are in admixture with the first adhesive layer. In another arrangement, the capsules are in contact with at least a portion of the second surface of the first adhesive layer, such as being contained in a second adhesive layer disposed proximal to or on a second surface of the first adhesive layer.

The capsules containing the second adhesive may be designed to prevent premature activation of the second adhesive, such as by preventing premature rupturing of the capsules and vapor communication between the second adhesive and the atmosphere. In this regard, the capsules generally include a shell of vapor impermeable material. Furthermore, the capsules may have a crush strength sufficient to withstand forces encountered during normal production, transport and stocking operations. Moreover, the capsules may also be designed to be activated upon application of a predetermined amount of pressure. In this regard, the capsules are generally substantially spherical, micron-sized capsules having an outer shell made up of a plastic, glass, or ceramic material. In one arrangement, the outer shell of the capsules comprises a silicate material. In another arrangement, the outer shell of the capsules comprises a ceramic material. The average diameter of the capsules is generally from about 0.1 micron to about 350 microns. Tailoring the specific properties of the capsules (e.g., material size and/or crush strength) enables the capsules to have a desired crush strength for a particular application.

As noted, the adhesive covering includes a first adhesive layer. This first adhesive layer may be relatively thin, flexible and/or waterproof. In this regard, the first adhesive layer may include a bitumen-containing material.

In another aspect of the present invention, a multi-functional covering is provided, the multi-functional covering including an adhesive membrane and a plurality of the capsules associated with the adhesive membrane, each of the capsules containing a second substance that is compositionally different from the adhesive membrane, for imparting a desired characteristic to the adhesive membrane. The adhesive membrane may include any or all of the properties of the adhesive membrane described above with respect to the adhesive covering. That is, the adhesive membrane may include a backing layer, an adhesive layer disposed on the backing layer and, or a release layer. The adhesive layer may include an adhesive, such as a bitumen-containing material.

The second substance may be a second adhesive in accordance with the above noted aspect, or, the second substance may be a chemical. Such a chemical may be any chemical adapted to be encapsulated in the capsules and that can provide a function to the multifunctional covering. For example, the chemical may be an organism repellent material, such as an insecticide or pesticide. In one embodiment, the chemical is a termiticide.

As noted, the capsules of the multi-functional covering are associated with the adhesive membrane. In this regard, the capsules may be contained within the bounds of the adhesive membrane, or proximal to or on the perimeter of the adhesive membrane. In one approach, the capsules are contained within the bounds of an adhesive layer.

It will be appreciated, that various combinations of the above described aspects and arrangements may be utilized in conjunction with the present invention. For example, the adhesive covering of the present invention may further include first and second pluralities of capsules, wherein the first and second pluralities contain, for example, a second adhesive and a chemical, respectively, where the chemical is compositionally different from the second adhesive. These second plurality of capsules may be located in any desired position within the adhesive covering, such as in admixture with the first adhesive layer, in admixture with a second adhesive layer or disposed proximal to or on the perimeter of any such first adhesive or second adhesive layers.

In accordance with the above objectives, a method for making a peel and stick multi-adhesive covering is also provided, the method including the steps of contacting a bitumen-containing material with capsules containing a second adhesive, forming a multi-adhesive sheet, and applying a peel-away release layer to the multi-adhesive sheet. The capsules may contact the bitumen-containing in any suitable manner. In one approach, the contacting is accomplished by admixing the capsules with a bitumen-containing material. In this regard, prior to the contacting the bitumen-containing material with the capsules, the bitumen-containing material may be heated to a liquid or near-liquid state. The capsules may be mixed with the liquid/near-liquid bitumen-containing material, and the admixture may be formed into a multi-adhesive sheet, such as by cooling the admixture. In another approach, the contacting step may also or alternatively include the step of placing capsules onto a surface of a bitumen-containing material, such as by spraying, coating or otherwise. A backing material may be also applied to a second surface of a bitumen-containing material.

In another aspect of the present invention, a method for creating a waterproof surface is provided. The method including the steps of orienting a waterproof covering in relation to a surface, where the waterproof covering contains a bitumen containing layer defining a first adhesive and at least a second adhesive. The method further includes contacting the surface with the waterproof covering, activating a second adhesive and adhering the waterproof covering to the surface, where the second adhesive at least assists in adhering the waterproof covering to the surface. The method may optionally include the step of removing a peel-away release layer prior to the contacting.

The step of activating the second adhesive can occur before, upon or after the surface is contacted by the waterproof covering. In one arrangement, the activating step includes rupturing capsules containing a second adhesive to release the second adhesive. The activating step can be accomplished in various manners, such as by forcibly pressing the covering against the surface, for example, during the contacting step, and rupturing capsules containing the second adhesive. In this regard, the contacting step can at least partially assist in the activating. The activating step can include the activation of all the second adhesive or only a portion of the adhesive. For example, the activating step may include applying a force to one or more portions of the waterproof covering. Alternatively, the activating step may include exposing only a portion of the second adhesive to a radiation source, such as UV light.

As noted above, the adhering step is generally assisted by the second adhesive. In this regard, the adhering step may include bonding a second adhesive to a portion of the surface to which the waterproof covering is to be adhered and bonding the second adhesive to a portion of the waterproof covering. In one approach, the bonding includes permeating the second adhesive through the first adhesive layer. As noted above, the second adhesive generally has a bonding strength sufficient to maintain the waterproof covering in the desired orientation at least until a first or primary adhesive of the waterproof covering (e.g., a bitumen-containing material) can bond to the surface. In this regard, the adhering step may further include using the second adhesive to maintain a fixed position relationship between the waterproof covering and a surface while the bitumen-containing material bonds to the surface, where during the bonding step the second adhesive has a bonding strength greater than that of the first adhesive. In one approach, the adhering includes diffusion of a portion of the first adhesive through a second adhesive layer and bonding that portion of the first adhesive to the surface.

The surface to which the waterproof covering is to be bonded can be any surface in which waterproof qualities would be desired. For example, the surface to which the waterproof covering is to be bonded could be a surface of a building construction material, such as a wood-containing material, like oriented strandboard.

In yet another aspect of the present invention, a method for creating a multi-functional surface is provided, the method including the steps of orienting a covering in relation to a surface, the covering including an adhesive layer and a plurality of capsules containing a chemical, contacting the surface with the covering, and adhering the covering to the surface, wherein the adhesive at least assists in the adhering, and where the adhesive layer is adapted to provide a first characteristic in relation to the surface and the chemical is adapted to provide a second characteristic different than the first characteristic in relation to the surface. In one embodiment, the first characteristic is waterproofing and the second characteristic is organism repelling. In another embodiment, the first characteristic is waterproofing and the second characteristic is organism terminating. According to this aspect, the contacting and adhering steps can be accomplished by any desired methods, including any of those described in relation to the method for creating a waterproof surface, above. In one approach, the covering can include capsules containing a secondary adhesive, where the method further includes the step of activating the secondary adhesive. The method may further include a second activating step, where the chemical is activated. In this regard, the step of activating the adhesive and the step of activating the chemical may be non-overlapping. That is, the step of activating the chemical may begin before, after or during the step of activating the secondary adhesive. It will be appreciated that, when the chemical is an organism repellant chemical, the second activating step will generally occur after the step of activating the secondary adhesive, but may, in some instances, occur during the step of activating the secondary adhesive. The step of activating the chemical may include rupturing an outer shell of at least one capsule containing the chemical. For example, an organism, such as an insect, rodent, or other unwanted species, may contact the outer shell of a capsule, such as by biting, burrowing or otherwise attempting to penetrate the covering. Such action by the organism may cause the outer shell of the capsule to rupture, exposing the organism to the chemical. Such exposure may expel, repel, terminate or otherwise deter the organism from further damaging the covering or penetrating the substrate or the building.

### BRIEF DESCRIPTION OF THE FIGURES

FIG. 1 illustrates a cross-sectional view of one embodiment of an adhesive covering of the present invention.

FIGS. 2(A)-2(C) illustrate a process for adhering an adhesive covering to a surface in accordance with the present invention.

FIG. 3 illustrates a cross-sectional view of one embodiment of an adhesive covering of the present invention.

FIG. 4 illustrates a cross-sectional view of one embodiment of an adhesive covering of the present invention.

FIG. 5 illustrates a flow diagram of an embodiment of a method of the present invention.

FIG. 6 illustrates a flow diagram of an embodiment of a method of the present invention.

FIG. 7 illustrates a cross-sectional view of one embodiment of a multi-functional covering of the present invention.

FIG. 8 illustrates a cross-sectional view of one embodiment of a multi-functional covering of the present invention.

FIG. 9 illustrates a cross-sectional view of one embodiment of a multi-functional covering of the present invention.

FIG. 10 illustrates a cross-sectional view of one embodiment of a multi-functional covering of the present invention.

FIG. 11 illustrates a flow diagram of an embodiment of a method of the present invention.

FIG. 12(A)-12(C) illustrate perspective views of one embodiment of the application of an adhesive covering to a surface.

FIG. 13 illustrates a perspective view of one embodiment of the application of a multi-functional covering of the present invention.

### DETAILED DESCRIPTION OF INVENTION

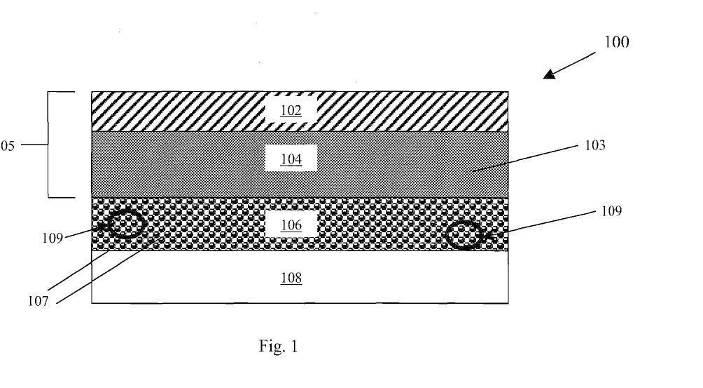

Reference will now be made to the accompanying drawings, which at least assist in illustrating the various pertinent features of the present invention. FIG. 1 illustrates a cross-sectional view of an adhesive covering of the present invention. The adhesive covering 100 (not to scale) includes a backing layer 102, a first adhesive layer 104 including a first adhesive 103 and a second adhesive layer 106 including a second adhesive 107. The adhesive covering may also include a peel-away release layer 108. The first adhesive layer 104 and backing layer 102 generally define an adhesive membrane 105, such as those described in commonly-owned U.S. Pat. No. 6,676,779, which is hereby incorporated herein by reference in its entirety.

The first adhesive 103 can be any material adapted to adhere to and, in some instances, waterproof a surface. For example, the first adhesive 103 may include a bitumen-containing material. Examples of suitable bitumen-containing materials include various tar adhesives and rubberized asphalts, as well as certain butyl-rubber compounds (e.g., polyisobutylene). In the illustrated embodiment, the first adhesive 103 includes a modified, rubberized asphalt material. The rubberized asphalt material comprises a combination of petroleum, asphalt/road flux components (i.e., bituminous components), carbonate components such as calcium carbonate, styrene-isoprene-styrene block G co-polymer components, and miscellaneous stabilizing additives.

The first adhesive layer generally has a thickness sufficient to provide the desired qualities in relation to the application the covering is to be used. For example, when the covering is to be utilized as a covering in building construction applications, the adhesive layer generally has a thickness of from about 20 mils to about 120 mils.

The adhesive membrane 105, as shown, includes a backing layer 102 to improve the strength and dimensional stability of the adhesive covering 100. However, it will be appreciated that the adhesive covering 100 may simply comprise the first adhesive layer 104 without a backing layer to provide a covering 100 with increased flexibility. Preferably, the backing layer 102 is constructed from a material that is elastically deformable to allow the adhesive covering 100 to be easily rolled for transportation or storage, unrolled for application, and to conform to a surface without undesired creases or bends. For example, suitable backing layer materials include sheet-like materials made from papers, fabric, synthetic foams, and films. The adhesive membrane 105 may also include a polyester mesh reinforcing layer (not shown) sandwiched between two or more adhesive layers.

The adhesive covering 100, as noted, may include a peel-away release sheet 108 to prevent undesired sticking of the covering's adhesive surfaces during transport and storage or while the covering is being positioned/shaped. Many different foils, films, papers or other sheet materials are suitable for use in constructing the release sheet 108. For example, the release sheet may comprise a metal, plastic, or paper sheet treated with silicon or other substances to provide a low level of adhesion to the first and/or second adhesive materials 103, 107.

The second adhesive 107 may be any material adapted to readily adhere to the surface and a portion of the adhesive covering. Particularly useful second adhesives include, without limitation, natural and synthetic rubbers, acrylics and acrylic resins, to name a few.

Generally, the second adhesive 107 is contained within a plurality of capsules 109. The capsules 109 may be made of any material designed to contain the second adhesive 107. The capsules 109 should further preventing premature activation of the second adhesive 107, such as by preventing premature rupturing of the capsules 107 and vapor communication between the second adhesive 107 and the atmosphere. In this regard, the capsules 109 can include a shell of vapor impermeable material. Suitable vapor impermeable materials include, without limitation, glass, ceramics and plastics, such as polyethylenes, polypropylenes, polyvinylchlorides, and polytetrafluorides. Furthermore, the capsules 109 should have a crush strength sufficient to withstand forces encountered during normal production, transport and stocking operations, such as from at least about 15 psi, such as at least about 25 psi.

The capsules 109 should also be designed to be activated upon application of a certain amount of pressure, such as an amount of pressure that can be applied by an average adult human. In this regard, the capsules 109 should have a crush strength of not greater than 1000 psi, such as not greater than about 500 psi, and in some instances not greater than 250 psi.

In one embodiment, and as depicted, the capsules 109 are substantially spherical. However, the capsules 109 may be any size and material suitable to contain the second adhesive. Substantially spherical capsules are preferred in some instances to assist in the creating of the adhesive covering 100, such as by helping facilitate the admixing of the capsules 109 with the first adhesive 103 or by enabling a fluid containing the capsules (e.g., a carrier gas) to contact a surface of the first adhesive, thereby applying the capsules to the surface of the first adhesive, discussed in further detail below.

The capsules 109 should be relatively small and lightweight to assist in reducing the volume and weight of the adhesive covering. Moreover, the capsules 109 should be relatively small and lightweight to assist in their integration with the first adhesive. However, the capsules 109 should also have a size sufficiently large to meet the necessary crush strength requirements. In this regard, the capsules should generally be micron-size, such as from about 0.1 micron to about 350 microns in diameter. The first adhesive 103 and second adhesive 107 may be integrated in any suitable arrangement to create the adhesive covering 100 so long as the second adhesive 107 remains inactive until a desired time, but, upon activation, the second adhesive 107 is able to contact and bond to a portion of a surface (e.g., a first portion of an OSB) and a portion of the covering (e.g., the first adhesive or the backing layer) during a first time period. For example, the second adhesive 107 may be contained within a plurality of capsules 109, and the capsules 109 may be sprayed or otherwise placed in contact with the first adhesive layer 104 to layer the capsules 109 on the surface of the first adhesive layer 104, creating a second adhesive layer 106.

The first adhesive 103 and second adhesive 107 should also be integrated to permit the first adhesive to bond/fuse to the same surface (the first portion of the OSB) or another surface (e.g., a second portion of an OSB) at a later, second period of time, for example, by permeating/migrating through the second adhesive layer 106. In this regard, it is often desirable to integrate the first adhesive and second adhesive via the above-described capsules 109. For example, and as depicted in FIG. 1, the first adhesive may be contained in a first adhesive layer 104 and the second adhesive may be contained in a second adhesive layer 106, contiguous to the first adhesive layer, as depicted in FIG. 1. It will be appreciated that any second adhesive layer 106 should be as thin as possible to assist in minimizing the cost and weight of the covering, as well as to promote diffusion of the first adhesive to the surface to be adhered. However, the second adhesive layer should also be thick enough to provide a sufficient amount of second adhesive to achieve the desired adherent qualities. In this regard, the second adhesive layer may have a thickness at least as large as a single layer of capsules but generally not greater than about 20 mils.

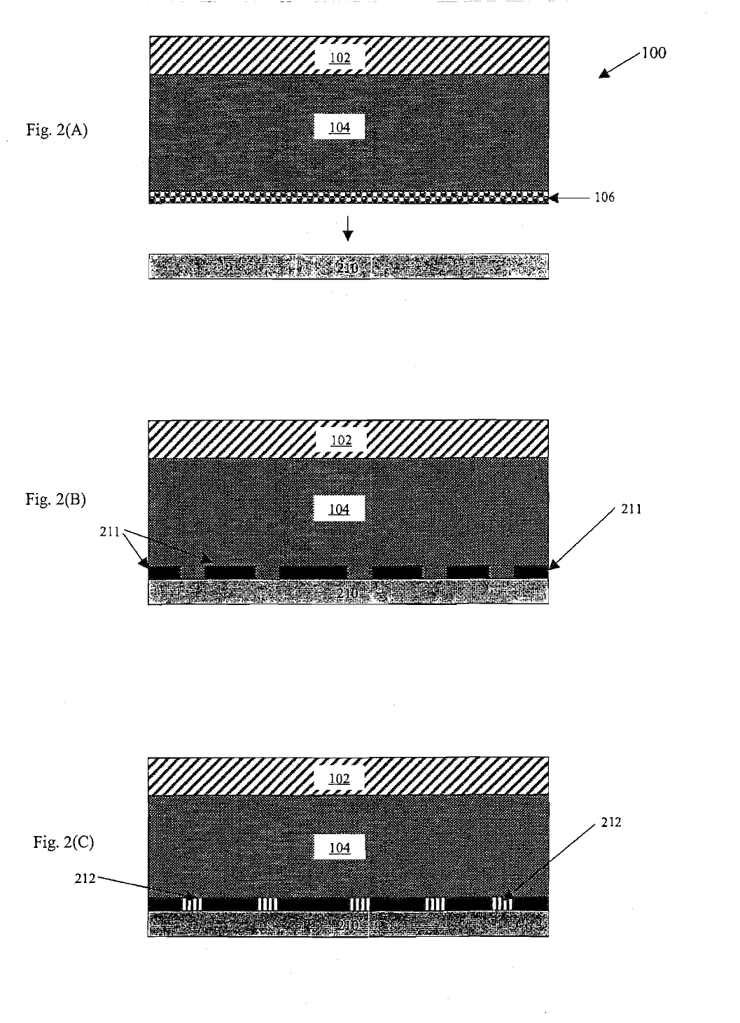

Referring now to FIGS. 2(A)-2(C) (not to scale), after any peel-away release layer has been removed (not shown) the adhesive covering 100 can be oriented in relation to a surface 210, and the covering 100 can be moved toward and ultimately contacted with the surface 210. Prior to, upon or after contacting the surface, the second adhesive 107 may be activated, such as by forcibly pressing the covering 100 against a surface (e.g., the surface to which the covering is to be adhered) to rupture capsules 109 containing the second adhesive 107. Alternatively, the second adhesive may be activated by a radiation source (e.g., UV light) or sonic energy. After activation, the second adhesive bonds to both a portion of the surface 210 and a portion of the covering (e.g., the first adhesive layer), thereby adhering the covering, via bonded second adhesive portions 211, to the surface during a first period of time. At a later, second period of time, the first adhesive 103 may fuse to the surface 210 via fused first adhesive portions 212.

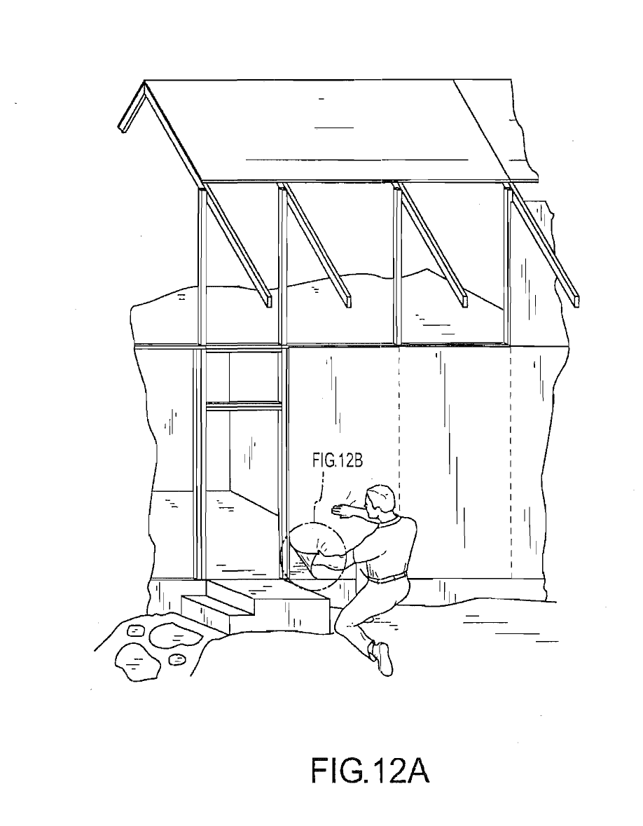

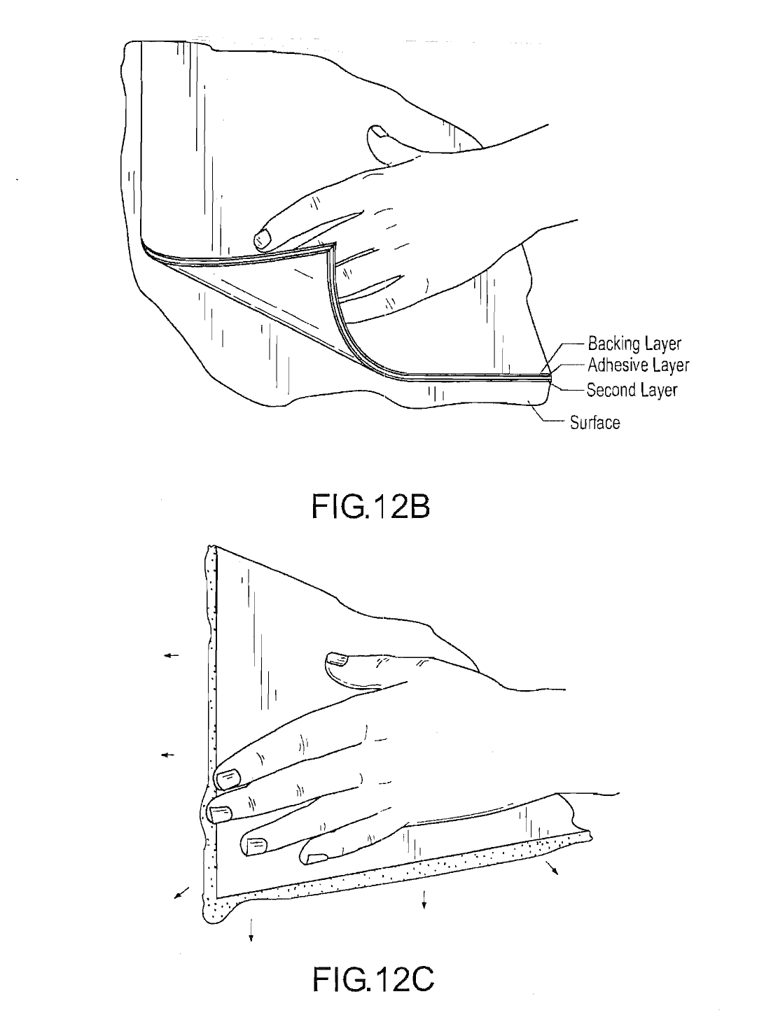

One embodiment of the application of an adhesive covering in relation to the construction of a building is illustrated in FIG. 12(A)-12(C). The adhesive sheet 100 can be applied to a surface of a building construction material, such as oriented strandboard. During application, portions of the adhesive covering may be activated, such as by pressing the adhesive covering against the building construction material to activate a second adhesive contained therein. Upon activation, the second adhesive can bond to a portion of the building construction material and a portion of the covering to maintain the covering in a fixed positional relationship for a period of time, such as an amount of time required for a bitumen-containing material to bond to a surface of the building construction material.

It will be appreciated that the terms “adhere”, “bond”, “fuse” and the like are used herein for the convenience of the reader and to facilitate understanding of the present invention. It will further be appreciated that such terms refer to a situation where an adhesive binds other materials in a certain orientation so as to prevent, under normal circumstances, such other materials from being appreciably moved from their orientation in relation to the adhesive, absent appreciable force. These terms (i.e., adhere, bond, fuse and the like) are not meant to limit the method by which such adhesive accomplishes the binding, whether it be by chemical reaction, physical interaction or otherwise.

As noted above, the first and second adhesive materials 103, 105 may be integrated in various arrangements, such as contiguous layers, as depicted in FIG. 1, above. In an alternate embodiment, as depicted in FIG. 3 (not to scale), the first adhesive 303 and second adhesive 307 may be integrated in the covering via a matrix 313 containing the first adhesive and a plurality of capsules 309 containing the second adhesive 307.

The matrix of first adhesive and capsules can be created, for example, by admixing the first and second adhesives. In this regard, it will be appreciated that the first adhesive may be in a liquid or near-liquid phase (e.g., above its melting point or congealing point) during the admixing to enable sufficient dispersion of the capsules within the first adhesive. Thus, in some instances it may be necessary to employ capsules that include a shell whose melting point is higher than the melting point or congealing point of the first adhesive. By way of illustration, if the first adhesive includes rubberized asphalt, whose congealing point can be above 150° C., the capsules' shell should have a melting point in excess of the congealing point of such rubberized asphalt. In this regard, the capsules' shell may be made from glass or ceramic materials.

Alternatively, the first adhesive may be in granule or particulate form and the capsules may be admixed with the particulate first adhesive without the need to liquefy the first adhesive. A binder or other suitable material may be used to join the first adhesive and capsules to create the matrix.

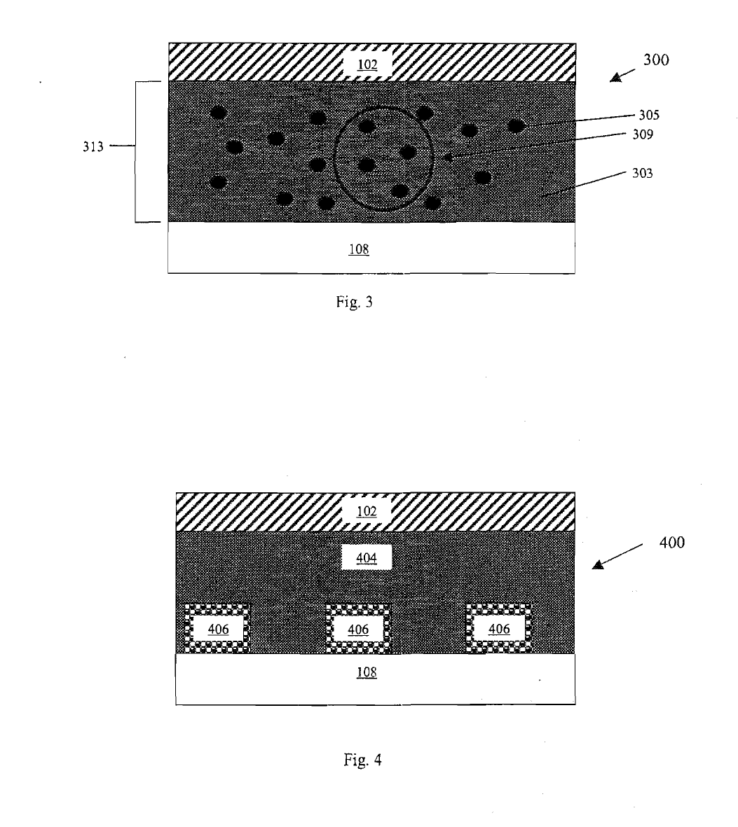

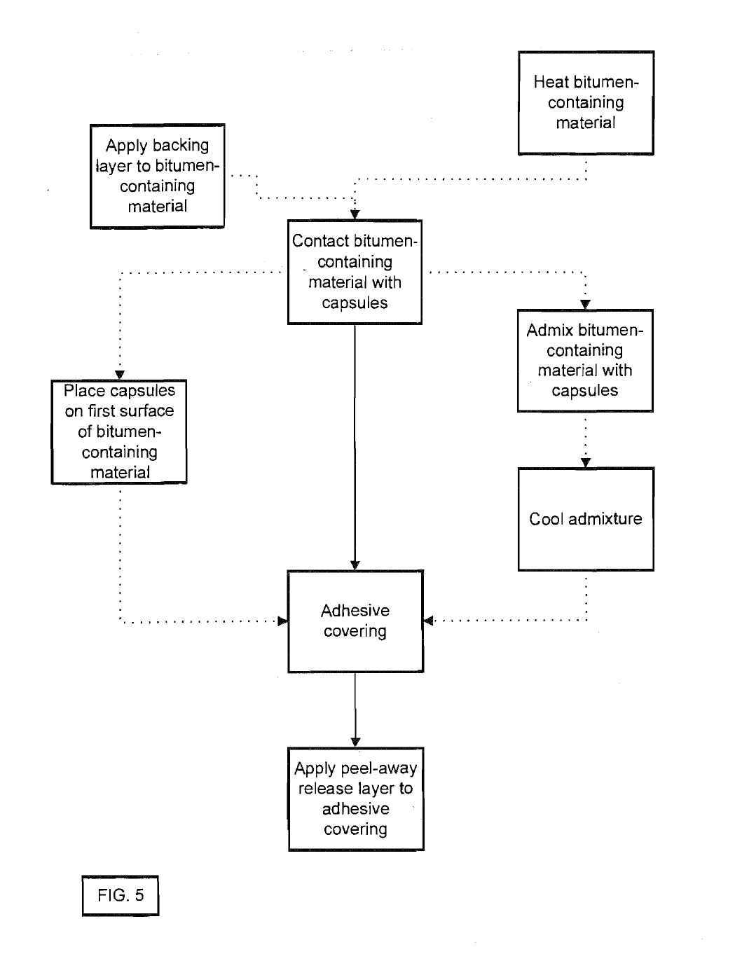

In another embodiment, as depicted in FIG. 4 (not to scale), the first adhesive 403 and second adhesive 407 may be integrated in the covering where the first adhesive is contained in a continuous first adhesive layer 404 and the second adhesive 407 may be contained in a series of second adhesive layers 406 disposed proximal or upon various portions of the first adhesive layer 404. As described above in reference to FIG. 1, each of the second adhesive layers 406 can include a plurality of capsules 409 containing the second adhesive 407.

As was described above in reference to FIGS. 1 and 2(A)-(C), after any peel-away release layer has been removed, the covering is placed in contact with a surface. Prior to, upon or after contacting the surface, the second adhesive is activated, such as by forcibly pressing the covering against the surface. After activation, the second adhesive bonds to both a portion of the surface and a portion of the covering (e.g., the first adhesive layer), thereby adhering the covering, via bonded second adhesive portions, to the surface for a first period of time. At a later, second period of time, the first adhesive may fuse to the surface via fused first adhesive portions.

It will be appreciated that, while the integration of the first and second adhesive within the covering has been primarily discussed in regards to discrete layers or matrices, any combination of layers and matrices can be used to in the adhesive covering of the present invention.

The dimensions of an adhesive covering is typically determined by the specifications of the structure to which the covering is applied. For example, in frame construction it is known that most structures utilize 4′×8′ OSB. Accordingly, the adhesive covering can be at least about 48 inches wide and at least about 96 inches long. However, the covering can be any dimensions necessary to cover a surface.

The thickness of the adhesive covering is generally determined by the application in which the adhesive covering is used. For example, in building construction, the adhesive covering can be from about 50 mils to about 500 mils thick, where any backing has a thickness of from about 25 mils to about 350 mils and where the first adhesive layer has a thickness of from about 20 mils to about 120 mils.

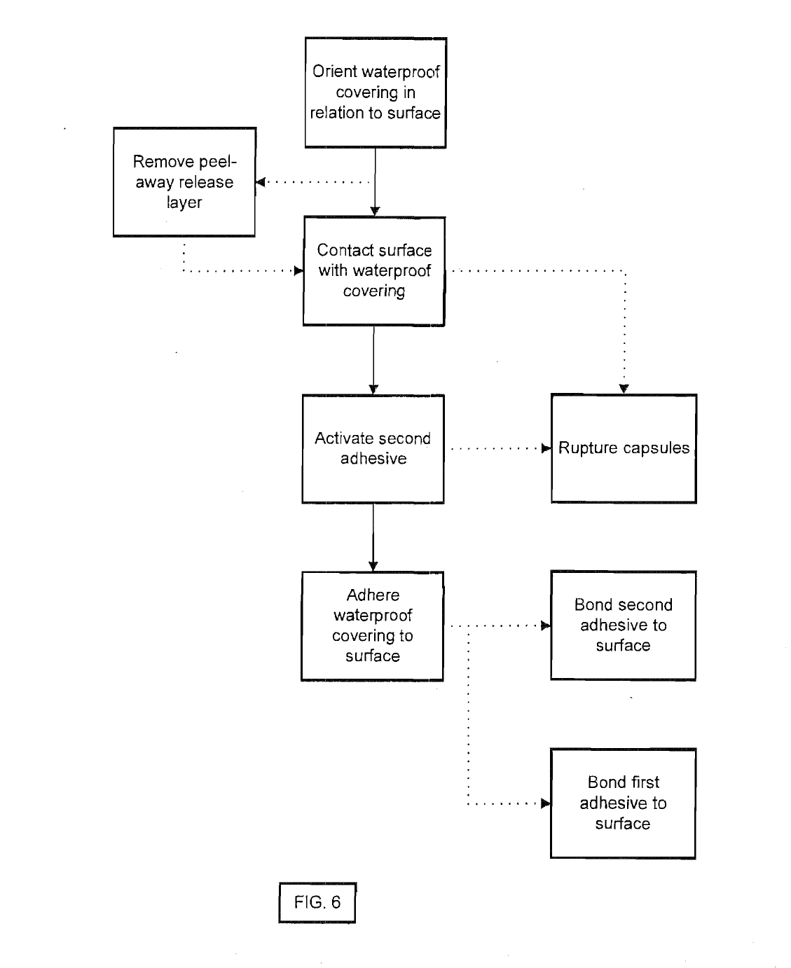

Referring now to FIG. 5, a method for producing a peel and stick adhesive covering is illustrated. The method generally includes the steps of contacting a bitumen-containing material with capsules containing a second adhesive to create a multi-adhesive sheet, and applying a peel-away release layer to the multi-adhesive sheet. The capsules may contact the bitumen-containing in any suitable manner. In one approach, the contacting is accomplished by admixing the capsules with a bitumen-containing material. In this regard, prior to the contacting the bitumen-containing material with the capsules, the bitumen-containing material may be heated to a liquid or near-liquid state. The capsules may be mixed with the liquid/near-liquid bitumen-containing material, and the admixture may be formed into a multi-adhesive sheet, such as by cooling the admixture. In another approach, the contacting step may also or alternatively include the step of placing capsules onto a surface of a bitumen-containing material, such as by spraying, coating or otherwise. A backing material may be also applied to a second surface of a bitumen-containing material. In one embodiment, the method includes the step of applying a backing to a first adhesive. The backing can be applied by any well known means, such as by lamination as described in commonly-owned U.S. Pat. No. 6,676,779, which is hereby incorporated herein by reference in its entirety.

Referring now to FIG. 6, a method for creating a waterproof substrate is illustrated. The method generally includes the steps of orienting a waterproof covering in relation to a surface, the waterproof covering including a first and second adhesive, contacting the surface with the waterproof covering, activating the second adhesive and adhering the waterproof covering to the surface, where the second adhesive at least assists in adhering the waterproof covering to the surface.

The contacting of the surface by the waterproof covering can be accomplished by any known means, such as by simply pressing or placing the waterproof covering onto the surface. Due to the lightweight nature of the waterproof covering, the contacting step can be accomplished by one or more persons (i.e., applicator(s)), and without mechanical interaction. However, if desired, the contacting step could also include the use of a mechanical device, such as the use of a roller or other device adapted to, for example, apply pressure to a surface of such waterproof coverings.

The step of activating the second adhesive can occur before, upon or after the surface is contacted by the waterproof covering. As noted above, the activating step can be accomplished in various manners, such as by forcibly pressing the covering against the surface, for example, during the contacting step, and rupturing capsules containing the second adhesive. As also noted above, the capsules generally have a crush strength adapted to withstand normal forces encountered in the production, storage and transport of the waterproof covering. The capsules also have a crush strength adapted to allow an applicator to activate the capsule, such as by pressing on the capsules. Thus, the activating step can also be accomplished without mechanical interaction. However, if desired, the capsules may be designed to require a mechanical interaction to activate the second adhesive, such as by designing the capsules to require a force that is not normally possible by an applicator absent mechanical interaction. In this regard, the capsules could be designed to rupture upon the application of a concentrated mechanical force, such as the amount of force normally delivered by a roller, hammer or other implement utilized by the applicator.

The activating step can include the activation of all the second adhesive or only a portion of the adhesive. For example, the activating step may include applying a force to one or more portions of the waterproof covering. Alternatively, the activating step may include exposing only a portion of the second adhesive to a radiation source or sonic energy. It will be appreciated that the outer shell and/or capsules should be designed to be activated upon the application of such energy, such as by choosing materials whose chemical composition changes upon the application of radiation or whose shell is adapted to rupture upon the application of such radiation or sonic energy.

The adhering step generally occurs after the activating step. As noted above, the adhering step generally is assisted by the second adhesive. In this regard, the second adhesive may bond to both a portion of the surface and a portion of the waterproof covering. Furthermore, and as noted above, the second adhesive generally has a bonding strength sufficient to maintain the waterproof covering in the desired orientation, such as maintaining the waterproof covering in the orientation provided during the orienting step.

In another aspect of the present invention, a chemical may be utilized in conjunction with an adhesive to create a multi-functional covering. For example, an adhesive membrane, defined by a backing layer and adhesive layer, may include a plurality of capsules, the capsules containing a chemical adapted to impart desired properties to the covering upon activation. By way of illustration, the capsules may contain an insecticide or pesticide to deter, repel or terminate insects, pests, rodents and other organisms that may come in contact with the multi-functional covering.

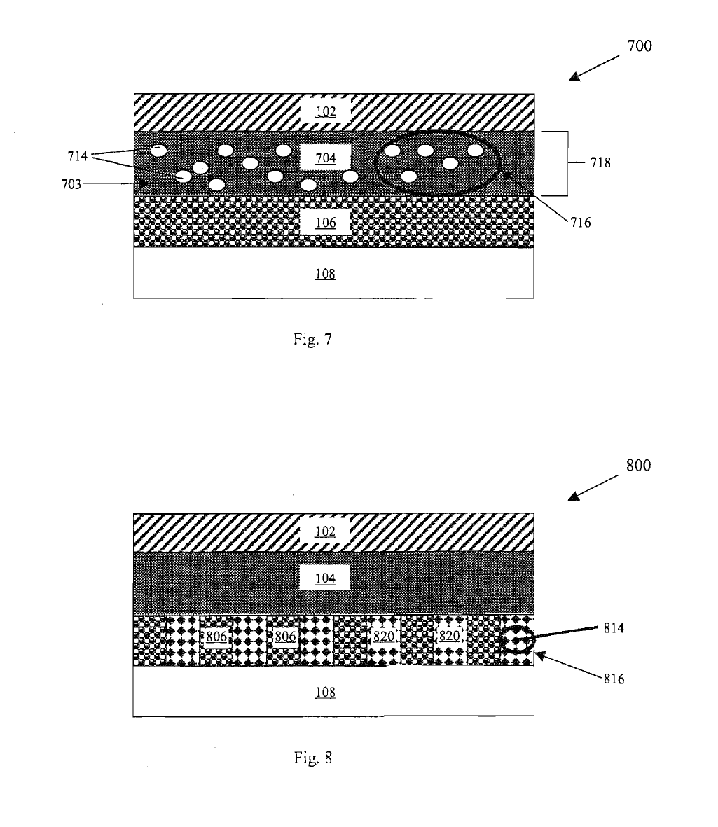

One embodiment of a multi-functional covering is FIG. 7 (not to scale). A plurality of other capsules 716 are located within a first adhesive layer 704. Each of the plurality of other capsules may contain a chemical 714, the chemical 714 being compositionally different from the second adhesive. Akin to the integration of the first and second adhesive described above in reference to FIG. 3, the first adhesive 703 and chemical 714 may be integrated in the covering 700 via a matrix 713 containing the first adhesive and a plurality of other capsules 716. As described above, a backing layer 102 and a peel-away release layer 108 may also be utilized with the covering 700.

The matrix of first adhesive and other capsules can be created, for example, by admixing the first adhesive and the other capsules, as was described above in relation to the admixing of the first adhesive and the second adhesive. Alternatively, the first adhesive may be in granule or particulate form and the other capsules may be admixed with the particulate first adhesive without the need to liquefy the first adhesive. A binder or other suitable material may be used to join the first adhesive and other capsules to create the matrix.

Another embodiment of a multi-functional covering is illustrated in FIG. 8 (not to scale), where a first adhesive may be in a continuous first adhesive layer 104, and the second adhesive 807 and chemical 814 may be integrated in the covering 800, where the second adhesive 807 and chemical may be contained in a series of second adhesive and chemical layers 806, 820 disposed on top of various portions of the first adhesive layer 104. As described above, each of the second adhesive layers 806 can include a plurality of capsules 809 containing the second adhesive 807 and each of the chemical layers 820 can include a plurality of other capsules 816 containing the chemical 814. As described above, a backing layer 102 and a peel-away release layer 108 may also be utilized with the covering 800.

As depicted, a plurality of second adhesive and chemical layers 806, 820 are planar with a first surface of the adhesive layer 104, and the second adhesive and chemical layers are about the same size as one another and alternate upon the first surface. However, it will be appreciated that a single second adhesive and single chemical layer could be utilized, the second adhesive layer(s) or chemical layer(s) may be any size, and any second adhesive and chemical layer(s) could be arranged in any manner on the surface of the adhesive layer.

Another embodiment of a multi-functional covering is illustrated in FIG. 9, where a chemical 914 may be integrated into the second adhesive layer 906. In this regard, the second adhesive layer 906 may contain a first plurality of capsules 909 containing a second adhesive 907 as well as a second plurality of capsules 916 containing the chemical 914.

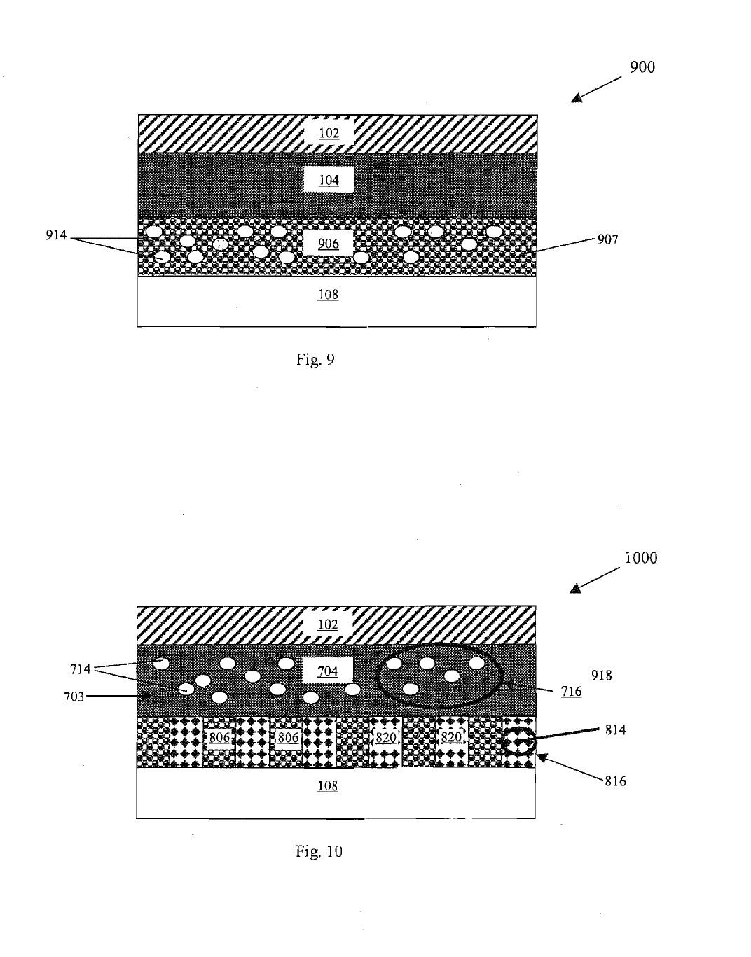

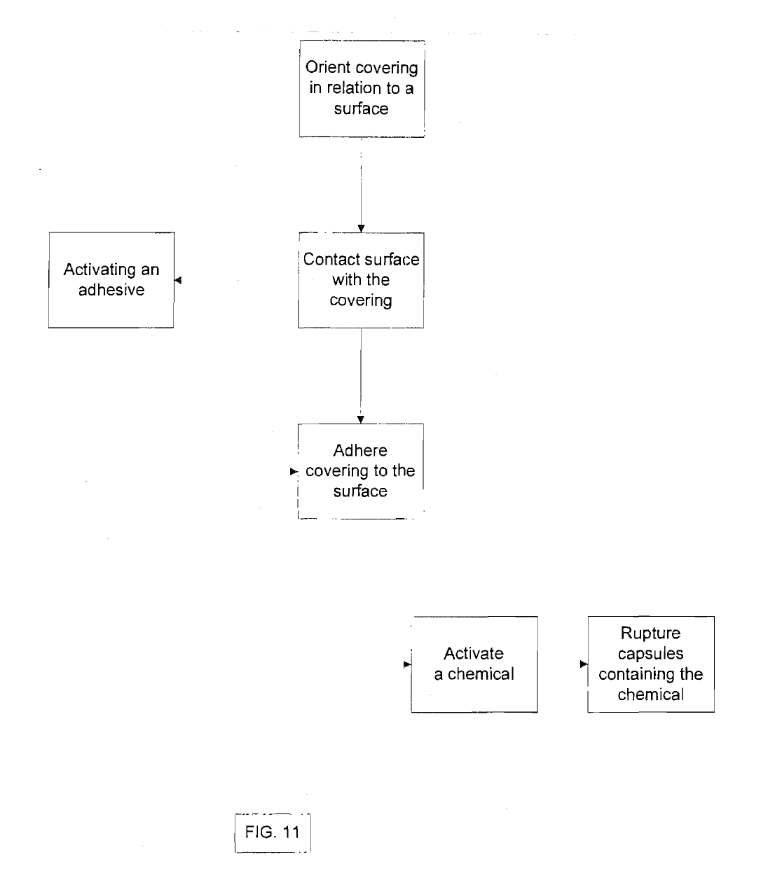

It will be appreciated that, while the above embodiments have been described using a chemical is associated with of the first adhesive layer, the second adhesive layer or in a chemical layer, combinations of the above approaches can also be utilized where a chemical is associated with various areas of the adhesive covering. For example, and as depicted in FIG. 10, a chemical 714, 814 may be associated with the first adhesive layer 704 and one or more chemical layers 820, where a plurality of capsules 816, 916 contain a chemical. It will also be appreciated that, while the above embodiments have been described in relation to multi-functional coverings using a first and second adhesive, the multi-functional covering could also employ only a single adhesive, such as a bitumen-containing adhesive layer, and capsules containing the chemical, where the capsules are associated with/integrated with the bitumen-containing layer.

The chemical can be any desired chemical that may provide a functionality to the multi-functional covering. For example, in one aspect the chemical may be an organism repellent material, such as an insecticide or pesticide, adapted to deter or terminate rodents, insects and other unwanted organisms. In one embodiment, chemicals that deter or terminate termites and other organisms known to damage and destroy wood products may be utilized, such as termiticides. Preferred termiticides include those that contain any of imidacloprid (e.g., PREMISE available from the Bayer Corporation, Elkhart Ind., United States of America), fipronil (e.g., TERMIDOR available from Rhone-Poulenc Agrochimie Corp., Lyon, France), and chlorfenapyr (e.g., PHANTOM available from BASF Aktiengesellschaft Corp., Rhein, Germany).

It will be appreciated that, in some instances, capsules containing the chemical may rupture upon application of the covering to a surface. In this regard, it may be desirable to utilize a chemical that is inert in relation to the other materials of the covering so as to prevent an unwanted change in the chemical make-up of the covering. For example, the chemical could be a pesticide that is inert in relation to the adhesive layer, before, after and/or during application of the covering to a surface. That is the chemical maintains its ability to be active within the covering after the covering has been applied to a surface. The chemical activity may be maintained by, as discussed above, encapsulating the chemical in capsules, or by choosing a chemical that will remain inactive in relation to the chemicals of the covering.

The chemical also can be a chemical that cause a change in the chemical properties of the first adhesive layer, such as by reacting with materials and/or catalyzing reaction of materials of the first adhesive and/or first adhesive layer to impart desired properties.

It will be appreciated that, when the first adhesive layer is desired to be waterproof, a bitumen-containing material may be utilized as the first adhesive. In this regard, the bitumen-containing material may be designed to have a melt point sufficient to withstand various weather conditions, such as high heat, so that the waterproof qualities of the layer do not deteriorate. It will also be appreciated that a low melt point is desired to impart flexible qualities to the bitumen-containing layer. These competing parameters can result in a melt-point of the bitumen-containing layer being high enough that the bonding strength of the bitumen-containing layer is insufficient to maintain the covering in place upon application.

In view of the foregoing, it has been recognized that a chemical may be utilized in such capsules to catalyze a reaction on a portion of the first adhesive layer surface such that the catalyzed portion would be more adherent than other portions of the surface. In this regard, a chemical may be utilized to catalyze a reaction on a surface of the first adhesive layer that lowers the melt point of the catalyzed portion to a degree sufficient to enable such catalyzed portion to adhere to another surface. After the chemical evaporates or otherwise dissipates from the covering, the catalyzed portions of the first adhesive layer would be “uncatalyzed” and such surface portions would return to their original state, providing them with the desired waterproof qualities at a desired melt point.

Alternatively, a chemical may react with a surface of the first adhesive layer to change its chemical properties. In this regard, the reacted surface portions of the first adhesive layer could be changed to enable them with more adherent qualities, such as by lowering their melt point or otherwise, which would enable the covering to be adhered to another surface. It will be appreciated that the reacted portions of the covering could be only a small fraction of the total adhesive layer, such as only a portion of a contact surface of the adhesive layer, thereby enabling the covering to be adhesive, but without losing any substantial other desired properties, such as waterproofing or temperature resistance qualities.

In another approach, the chemical may be simply air or an inert gas. The use of capsules containing air or an inert gas can help provide thermally insulative properties to the covering. In yet another approach, the capsules may be hallow capsules. Such capsules can also provide thermally insulative properties to the covering.

It will be appreciated that more than one type of chemical can be utilized in various capsules. For example, a first plurality of capsules may contain an insecticide and a second plurality of capsules may contain a pesticide. Alternatively, the first plurality of capsules may contain a termiticide and a second plurality of capsules may contain a third adhesive designed to provide a different bonding strength than other adhesives of the adhesive covering.

As will be appreciated, the capsules utilized for the chemical may share any or all of the characteristics of the capsules discussed in relation to the second adhesive. It will be also appreciated that, when both capsules containing second adhesive and capsules containing a chemical are used within a covering, the capsules containing the chemical should have a crush strength at least as large as the crush strength of the capsules containing the second adhesive to prevent the chemical-containing capsules from rupturing during production, storage and transport of the adhesive covering. It will further be appreciated that the chemical-containing capsules could also have crush strength greater than the crush strength of the second adhesive-containing capsules. Thus, when the second adhesive-containing capsules are activated, the chemical-containing capsules can remain inactive.

Referring now to FIG. 11, a method for adhering a multi-functional covering is provided. Generally, the method includes the steps of orienting a covering in relation to a surface, the covering including an adhesive layer and capsules containing a chemical, contacting the surface with the covering, and adhering the covering to the surface, wherein the adhesive at least assists in the adhering. The covering may also include capsules including a secondary adhesive, where the method further includes the step of activating the secondary adhesive. The method may further include a second activating step, where the chemical is activated. In this regard, the step of activating the adhesive and the step of activating the chemical may be non-overlapping. That is, the step of activating the chemical may begin before, after or during the step of activating the secondary adhesive. It will be appreciated that, when the chemical is an organism repellant chemical, the second activating step will generally occur after, and in some instances, during the step of activating the secondary adhesive.

The step of activating the chemical may include rupturing an outer shell of at least one capsule containing the chemical. For example, the an organism, such as an insect, rodent, or other unwanted organism, may contact the outer shell of a capsule, such as biting, burrowing or otherwise into the covering. Such action by the organism may cause the outer shell of the capsule to rupture, exposing the organism to the chemical. Such exposure may expel, repel, terminate or otherwise deter the organism from further damaging the covering.

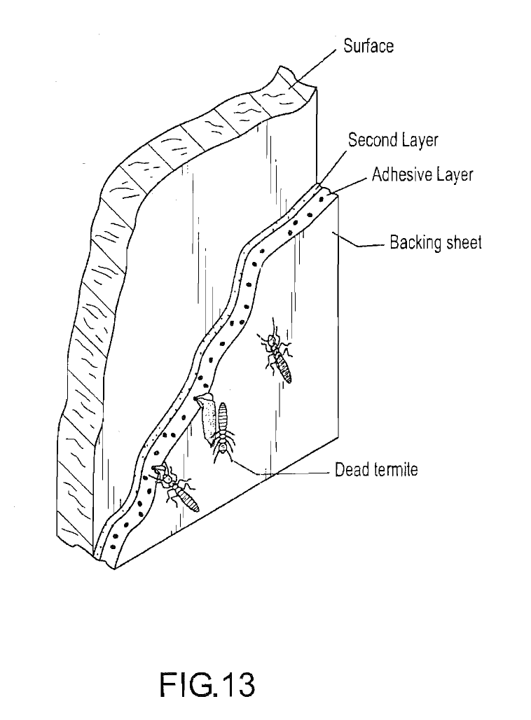

One embodiment of a use of a multi-functional covering is provided in FIG. 13, where the multi-functional covering includes an adhesive layer including capsules that contain a termiticide. As the termites burrow into the covering, they encounter the capsules and rupture such capsules. The ruptures capsules containing the termiticide acts to deter, repel and/or terminate the termites proximal to the covering.

In another arrangement, a person may detect the presence of an unwanted organism, such as termites (e.g., via visual inspection). Upon detection, the person can activate the chemical within the multi-functional covering, such as by applying a force to the covering. The force can cause the chemical to be activated, such as by rupturing capsules containing the chemical, thereby exposing the termites or other unwanted organism to the chemical. The chemical may then deter, repel and/or terminate organisms proximal to the covering.

In one approach a first plurality of capsules (e.g., adhesive-containing capsules) may be located at a first location of the covering (e.g. on the perimeter) and a second plurality of capsules (e.g., chemical-containing capsules) may be located at a second location different than the first location (e.g., within such perimeter) such that at a first time period the first plurality of capsules may be activated at the first location and at a second time period the second plurality of capsules may be activated. The first and second locations may include visual or other sensory indicators (e.g., color coding) to enable a user to determine such first and second locations.

While various embodiments of the present invention have been described in detail, it is apparent that modifications and adaptations to those embodiments will occur to those skilled in the art. It is to be expressly understood, however, that such modifications and adaptations are within the scope of the present invention, as set forth in the claims below. Further, it should be recognized that any feature of any embodiment disclosed herein can be combined with any other feature of any other embodiment in any combination. Particularly, it should be recognized that any feature, aspect, approach, embodiment or otherwise disclosed herein can be utilized in any combination with the various features, aspects, approaches, or embodiments disclosed herein.

1. An adhesive covering comprising:
a backing layer;
a first adhesive layer having a first surface in contact with at least a portion of said backing layer and an opposing second surface, said first adhesive layer comprising a first adhesive; and
a second adhesive associated with said second surface of said first adhesive layer, said second adhesive being different from said first adhesive.

2. The adhesive covering of claim 1, further comprising:
a peel-away release layer disposed over said second surface of said first adhesive layer, wherein said first adhesive layer is positioned between said backing layer and said peel-away release layer.

3. The adhesive covering of claim 1, wherein said second adhesive comprises a second adhesive layer.

4. The adhesive covering of claim 1, further comprising:
a plurality of capsules, each of said plurality of capsules containing a portion of said second adhesive.

5. The adhesive covering of claim 4, wherein said plurality of capsules are in admixture with said first adhesive layer.

6. The adhesive covering of claim 4, wherein said plurality of capsules are in contact with said second surface.

7. The adhesive covering of claim 4, wherein said plurality of capsules comprise a silicate shell.

8. The adhesive covering of claim 4, wherein said plurality of capsules comprise a ceramic shell.

9. The adhesive covering of claim 4, wherein said plurality of capsules are substantially spherical.

10. The adhesive covering of claim 9, wherein said plurality of capsules have an average diameter of from about 0.1 micron to about 350 microns.

11. The adhesive covering of claim 4, wherein said plurality of capsules have a crush strength of not greater than 1000 PSI.

12. The adhesive covering of claim 1, wherein said adhesive covering is flexible.

13 The adhesive covering of claim 1, wherein said adhesive covering is waterproof.

14. The adhesive covering of claim 13, wherein said first adhesive comprises a bitumen-containing material.

15. The adhesive covering of claim 14, wherein said bitumen-containing material comprises rubberized asphalt.

16. The adhesive covering of claim 14, wherein said bitumen-containing material comprises polyisobutylene.

17. The adhesive covering of claim 1, wherein said first adhesive layer has a thickness of not greater than 120 mils.

18. The adhesive covering of claim 1, wherein said second adhesive comprises a second adhesive layer and wherein said second adhesive layer has a thickness of not greater than 20 mils.

19. The adhesive covering of claim 1, wherein said first adhesive has a first bonding strength for bonding said covering to a surface and said second adhesive has a second bonding strength for bonding said covering to said substrate.

20. The adhesive covering of claim 19, wherein said first bonding strength is less than said second bonding strength during a first time period.

21-42. (canceled)

43. An adhesive covering comprising:
an adhesive membrane comprising:
a backing layer; and
an adhesive layer disposed on said backing layer, said adhesive layer comprising a first adhesive and a contact surface opposing said backing layer;
a plurality of capsules associated with said contact surface, each of said plurality of capsules containing a second adhesive.

44. The adhesive covering of claim 43, further comprising:
a peel-away release layer disposed over said contact surface, wherein said second adhesive layer is disposed between said backing layer and said release layer.

45. The adhesive covering of claim 43, wherein said adhesive layer comprises a bitumen-containing material.

46. The adhesive covering of claim 43, wherein said adhesive membrane is waterproof.

47. The adhesive covering of claim 43, wherein said adhesive membrane is flexible.

48. The adhesive covering of claim 43, wherein said first adhesive has a first bonding strength and wherein said second adhesive has a second bonding strength.

49. The adhesive covering of claim 48, wherein said second bonding strength is greater than said first bonding strength during a first period of time.

50. The adhesive covering of claim 49, wherein said first bonding strength is at least as large as said second bonding strength during a second period of time.

51.-69. (canceled)
